(19) United States
(12) Patent Application Publication
(10) Pub. No.: US 2013/0139550 A1
(43) Pub. Date: Jun. 6, 2013

(54) RECYCLING OF SILICON SAWING SLURRIES USING THERMAL PLASMA FOR THE PRODUCTION OF INGOTS OR WAFERS

(71) Applicant: Commissariat A L'Energie Atomique Et Aux Energies Alternatives, Paris (FR)

(72) Inventor: Etienne BOUYER, Grenoble (FR)

(73) Assignee: Commissariat A L'Energie Atomique Et Aux Energies Alternatives, Paris (FR)

(21) Appl. No.: 13/751,497

(22) Filed: Jan. 28, 2013

Related U.S. Application Data
(63) Continuation of application No. PCT/FR2011/051331, filed on Jun. 10, 2011.

(30) Foreign Application Priority Data
Jul. 30, 2010 (FR) 10.56299

(51) Int. Cl. C01B 33/021

(52) U.S. Cl. CPC C01B 33/021
USPC 65/23; 427/452

(57) ABSTRACT

A thermal plasma, advantageously inductive, is used to purify silicon from sawing slurries. For this purpose, a thermal plasma is generated; sawing slurries containing silicon are submitted to the thermal plasma, to form the silicon deposit on the substrate.

### FIELD OF THE INVENTION

The present invention relates to the field of the preparation of high-quality/purity silicon (Si), especially solar-grade silicon (PV) from sawing slurries.

More specifically, it provides treating the sawing slurries generated in photovoltaics or microelectronics by means of the inductive thermal plasma technique to purify the silicon contained in these slurries and recover it in the formed of ingots or wafers.

### PRIOR STATE OF THE ART

Solar industry is now rapidly growing. Photovoltaic (PV) silicon (Si) is currently preponderating since this technology is mature as compared with other possible candidate technologies.

In solar photovoltaic technology, a privileged way of elaborating the basic silicon elements results from the purification of metallurgical-grade Si. The ingots resulting from the successive purification phases are then sawn into wafers. This step causes the production of purified silicon wastes, mixed with cutting agents (originating from the saw, for example, SiC, diamond . . . ) and lubricants. The estimate of the level of wastes may range up to 50%.

As previously mentioned, the production of photovoltaic-grade silicon is based on the use of metallurgical-grade silicon, which will be purified before undergoing processing steps: melting, recrystallization, ingot sawing. These different steps eventually provide “wafers”. The PV Si ingot sawing step generates sawing slurries. This sawing step introduces impurities (for example, iron) which must be eliminated since they are harmful to achieve the necessary level of purity and thus of PV performance.

The recycling of sawing slurries thus is a constant concern, which requires the recovery and the purification of the silicon contained therein.

Studies by low-temperature methods, for example, by acid treatment and electrokinetic separation, have revealed the possibility of efficiently purifying the silicon originating from sawing slurries (T.-H. Tsai, <<Pretreatment of recycling wiresaw slurries—Iron removal using acid treatment and electrokinetic separation>>, Separation and Purification Technology, 68 (2009) pp. 24-29).

Other physical and chemical separation methods result in obtaining high-purity materials (up to 10 N), as for example described in document WO 2009/126922.

However, such processes are very long, and may range from approximately one hour to some hundred hours. Further, the acid treatment method emits liquid effluents which will have to be processed. At the end of such processes, the formed product is a purified silicon powder of variable coarseness.

It should be noted that the microelectronics industry also generates waste during the sawing phase. Here again, such waste corresponds to products based on very pure silicon, the recycling of which is a major issue.

The present invention thus falls within the search for new technical solutions enabling to recover the silicon contained in Si ingot sawing slurries.

### DISCUSSION OF THE INVENTION

In its more general aspect, the present invention relates to the use of the thermal plasma for the purification of silicon from sawing slurries.

Advantageously, the plasma is an inductive thermal plasma.

“Partly purified sawing slurry” designates silicon particles mainly originating from purified silicon ingots to which contaminants originating from the tool which has been used to saw the ingot, especially carbon, iron, SiC . . . , have been added. Silicon (Si) powders generally have an average grain size ranging between 0.1 and 10 micrometers.

It has been shown, in the context of the present invention, that what it called the thermal plasma technique is perfectly well adapted to the treatment of such feedstock originating from the PV solar industry and from the microelectronics industry.

The plasma technique, well known by those skilled in the art, enables to deposit a feedstock, typically a powder, a liquid, or a suspension, by introducing it into a plasma jet originating from a plasma torch. In the jet, the feedstock is incited and propelled towards a substrate. The molten droplets rapidly solidify and form a deposit on the substrate.

Commonly, the plasma jet may be generated in two ways:
by direct current (DC plasma);
by inductive or RF plasma (high-frequency or radio frequency inductive coupling) where the power is transferred by induction from a coil to the plasma jet, an AC RF current flowing through the coil.

According to the invention, the sawing slurries are advantageously treated by inductive or RF thermal plasma, which provides the possibility of a larger treatment volume as well as of a higher purity level.

Indeed, this type of high-purity plasma requires no electrode for the plasma generation. The corresponding plasma device is considered as a high-temperature chemical reactor enabling physical transformations (melting, evaporation, condensation, purification) and chemical reactions (synthesis, reduction, oxidation, introduction or separation of dopant elements) to occur therein. In terms of process, the relatively long time of residence in this type of plasma, coupled to high temperatures (>10,000 K), enables to perform the previously-mentioned physicochemical transformations.

Further, the control of the parameters of the plasma process (gas nature and flow rate, pressure, applied power, feedstock introduction mode) enables to determine the purity levels of the obtained silicon.

Further, the advantage of using the inductive thermal plasma is to be able to supply a large amount (flow rate) of feedstock, unlike a thermal plasma generated by direct current.

Due to the nature of the impurities contained in sawing slurries, typically carbon, silicon carbide, iron, thermal plasma is a method enabling to remove impurities without leaving tailings.

Thus, in the context of the invention, the possibility of using this technique to extract silicon from sawing slurries and to perform a deposition of purified silicon on a substrate of interest has been highlighted. As already mentioned, the degree of purity of the deposited silicon depends on the parameters of the applied plasma. In a preferred embodiment, the purity of the deposited silicon is such that it can be used in photovoltaics or in microelectronics.

The invention thus provides a relatively simple, efficient and fast way of recycling or re-using these slurries, by extracting or purifying the silicon present therein.

More specifically, the present invention relates to a method for forming a silicon deposit on a substrate, which comprises the steps of:
generating a thermal plasma;
submitting sawing slurries containing silicon to the thermal plasma, to form the silicon deposit on said substrate.

It should be noted that, advantageously, according to the invention, the sawing slurries containing the silicon are submitted to no prior treatment step, especially of purification, before being submitted to the thermal plasma. In other words, the method according to the invention enables, simultaneously and concurrently via the thermal plasma, to purify the sawing slurries containing the silicon and to form a silicon deposit on a substrate.

The thermal plasma is preferably inductive and is generated in a conventional way known by those skilled in the art and explained hereabove.

In the context of the present invention, the feedstock is essentially formed of sawing slurries originating from the sawing of silicon ingots. In practice, it contains silicon dust, as well as residues of the sawing tool, such as iron, SiC, carbon.

The plasma is applied to this feedstock which may be in solid form or in suspension.

In a preferred embodiment, the sawing slurries are mixed with a solvent, advantageously hydrogenated water, before being submitted to the plasma. The adding of a solvent enables to adjust the viscosity of the feedstock. According to this obtained viscosity, several methods of introduction of the feedstock into the plasma can be envisaged.

In the preferred case where the suspension plasma spray technique (described in document U.S. Pat. No. 5,609,921) is implemented, the biphasic mixture (liquid or solvent+fines resulting from the sawing) is atomized with an atomizing gas, such as for example argon, or helium, possibly completed with hydrogen up to 10% by volume, in a atomizing probe, to obtain drops formed of the solvent and of the silicon microparticles.

The used reducing gas mixture is especially useful to reduce the SiC.

As a variation, and according to the viscosity of the feedstock, said feedstock is conveyed to the plasma center via a propellant gas of same nature as previously.

When the sawing slurries are submitted to the inductive thermal plasma, the matter in presence, in the present case silicon microparticles, is melted and propelled towards a substrate. In the case where a solvent has been added, said solvent evaporates. The molten droplets solidify and form a deposit on the substrate, according to the thermal spray principle.

The substrate may be formed of a silicon ingot.

As a variation, the substrate may be formed of a refractory material, advantageously selected from the following group: molybdenum (Mo), tantalum (Ta), and tungsten (W) and the alloys thereof. In this case, the obtained silicon deposit is advantageously separated or extracted from the substrate which is then used as a support. Preferably, the substrate is cooled, for example, by being supported by a copper substrate holder run through by a water cooling circuit.

Preferably, before the extraction, the silicon deposit is submitted to the application of a plasma jet, enabling it to recrystallize in situ. During this step, the substrate may be submitted to a motion of rotating or lateral type. The plasma jet may be implemented in the same way as previously during the purification step by using the same equipment. Indeed, all the steps of purification and of possible recrystallization may be implemented within the same enclosure. Preferably, for this recrystallization step, a gas mixture of argon and hydrogen H₂ will be used.

According to a specific embodiment, when the substrate is a silicon ingot, the method according to the present invention thus enables to enrich said ingots. Indeed, the present invention provides a solution for reinjecting the sawing by-product formed by slurries into the PV cell manufacturing process.

In an alternative embodiment, and especially when the substrate having the deposition performed thereon is refractory, the method according to the invention enables to manufacture silicon wafers. As already mentioned, the parameters of the applied plasma enable to control the features of the formed deposit. In practice, the present invention enables to manufacture silicon wafers having a thickness ranging between 100 and 300 μm, of controlled thickness.

### BRIEF DESCRIPTION OF THE DRAWINGS

The way in which the invention may be implemented and the resulting advantages will better appear from the following non-limiting embodiments, in relation with the accompanying drawings, among which:

FIG. 1 illustrates a device and a method enabling to reload silicon ingots due to the passing of sawing slurries through an inductive thermal plasma.

FIG. 2 illustrates a device and a method enabling to form silicon wafers due to the passing of sawing slurries through an inductive thermal plasma.

FIG. 3 illustrates a device and a method enabling to crystallize, by in situ thermal processing, silicon wafers obtained due to the passing of sawing slurries through an inductive thermal plasma.

### EMBODIMENTS OF THE INVENTION

### 1/ Reloading of Silicon Ingots

The implementation of the method according to the invention, in the case where the substrate (2) is a silicon ingot, is illustrated in FIG. 1. Indeed, at the end of the process, the silicon ingot is enriched or reloaded with silicon.

Conventionally, the inductive thermal plasma comprises the following elements:
a coil 3, forming the plasma torch inductor, conducting an AC RF current;
a plasma jet 4, for example, argon and hydrogen (Ar/H₂).

In the case of an injection into the plasma center by spraying, an atomizing probe 5 is provided.

The implemented method can be broken up in three steps:

1—Feedstock Preparation:

The plasma device thus formed is supplied with feedstock 1, here formed of the recovered sawing slurries. The sawing slurries containing silicon in the form of dust or of fine particles arc added a solvent, advantageously hydrogenated water, to adjust the viscosity to the conditions suitable for the spraying.

2—Feedstock Spraying

The biphasic mixture (liquid and fines resulting from the sawing phase, the liquid corresponding to the residual liquid initially contained in the sawing slurries to which a solvent may be added to control the viscosity) is injected into the center of the plasma either by spraying, as described in document U.S. Pat. No. 5,609,921, or via a propellant gas, according to the viscosity.

In practice and as illustrated in FIG. 1, in the case of the spraying, an atomizing gas is added to the mixture, which then passes through atomizing probe 5. Droplets comprising solvent a silicon microparticles are thus formed.

The atomizing gas aims at dividing the continuous flow of slurries (possibly with an added solvent) into micro-droplets. As previously explained, having finely divided drops makes the thermal treatment in the plasma more efficient. The atomizing probe is the device which enables the gas flow (atomizing gas) to encounter the liquid vein (slurries) to form the droplets.

3—Forming of the Deposit:

On passing through the center of the plasma and under the action of Ar/H₂ plasma jet 4, the solvent is sprayed, the thin silicon particles are melted, accelerated, and deposit on ingot 2 and solidify.

Such a process enables to recover materials having a good purity level and to directly integrate them in the conventional silicon ingot manufacturing process, due to the thermal input necessary to shape the Si.

### 2/ Silicon Wafer Manufacturing

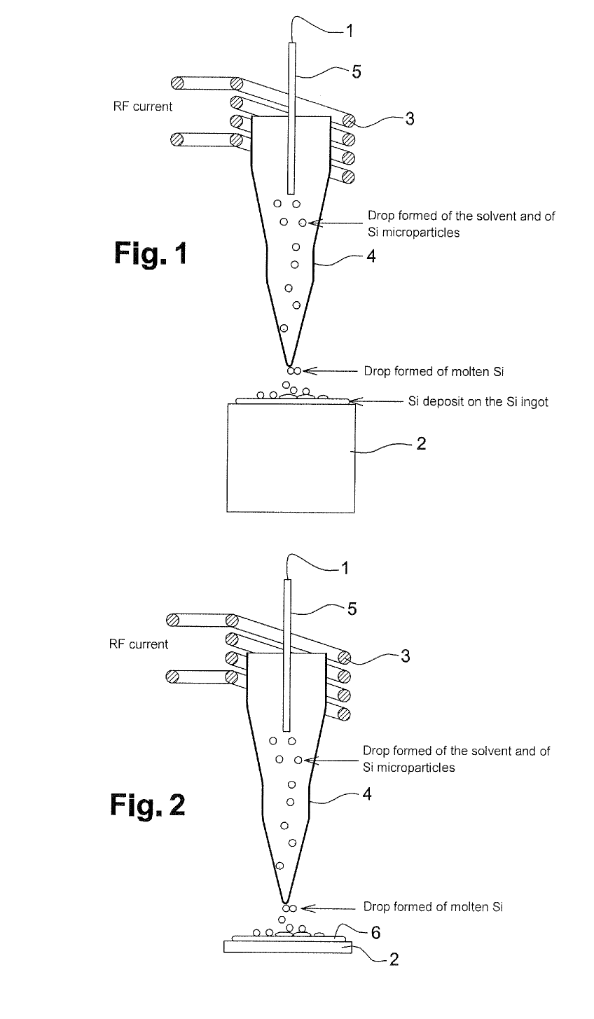

The method according to the invention has a second application: as illustrated in FIG. 2, it enables to directly form Si wafers from sawing slurries originating from Si ingots.

According to this variation, an equivalent method and device are implemented: the slurries are introduced into the inductive plasma by spraying, after which the Si melted by the plasma is recovered on a substrate 2′ to form an Si wafer of small thickness (6), generally ranging between 100 and 300 μm.

The main difference with the previous example is the nature of substrate 2′, which is no longer a silicon ingot, but a planar or non-planar support/substrate, preferably refractory. Thereby, the formed Si wafer 6 does not adhere to the support/substrate of refractory material selected for its properties of lack of reactivity with Si.

Preferably, the refractory substrate is itself cooled so that possible chemical reactions with the molten silicon are avoided on deposition on the substrate.

A subsequent step comprises extracting the formed Si wafer 6 from its support 2′.

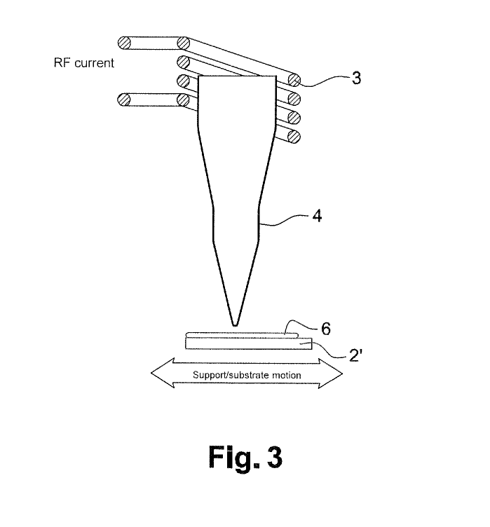

Before the extraction of the wafer and as illustrated in FIG. 3, it is possible to perform an in situ recrystallization of the formed Si wafer 6. This step comprises sweeping Si wafer 6 with plasma jet 4. This thermal treatment has the advantage of recrystallizing the Si grains forming the wafer by adjusting their size according to the passing time of the plasma jet at the surface, but also according to the intrinsic parameters of the plasma (power, composition, and flow rate of the plasma gases). In this step, it is possible to move substrate or support 2′ laterally or rotationally.

1. A method for forming a silicon deposit on a substrate comprising the steps of:
generating an inductive thermal plasma;
mixing sawing slurries containing silicon with a solvent, advantageously hydrogenated water;
submitting this mixture to the inductive thermal plasma, to form the silicon deposit on the substrate.

2. The method for forming a silicon deposit on a substrate of claim 1, according to which the sawing slurries are submitted to the plasma by spraying.

3. The method for forming a silicon deposit on a substrate of claim 1, according to which the sawing slurries are submitted to the plasma by means of a propellant gas, advantageously argon.

4. The method for forming a silicon deposit on a substrate of claim 1, according to which the substrate is a silicon ingot.

5. The method for forming a silicon deposit on a substrate of claim 1, according to which the substrate is made of a cooled refractory material, advantageously selected from the following group: Mo, Ta, W and the alloys thereof.

6. The method for forming a silicon deposit on a substrate of claim 5, according to which the silicon deposit is separated from the substrate.

7. The method for forming a silicon deposit on a substrate of claim 4, according to which the silicon deposit is submitted to the application of a plasma jet.

8. The method for forming a silicon deposit on a substrate of claim 5, according to which the silicon deposit is submitted to the application of a plasma jet.

9. The method for forming a silicon deposit on a substrate of any of claim 6, according to which the silicon deposit is submitted to the application of a plasma jet.

10. The method for forming a silicon deposit on a substrate of claim 7, according to which the substrate is moved during the application of the plasma jet.

11. A use of the method for forming a silicon deposit on a substrate of claim 4 to enrich silicon ingots.

12. A use of the method for forming a silicon deposit on a substrate of claim 5 for the manufacturing of silicon wafers, advantageously having a thickness ranging between 100 and 300 micrometers.
